(19) United States
(12) Patent Application Publication
(10) Pub. No.: US 2006/0057419 A1
(43) Pub. Date: Mar. 16, 2006

(54) High-strength steel product excelling in fatigue strength and process for producing the same

(76) Inventors: Toru Hayashi, Okayama (JP); Akihiro Matsuzaki, Okayama (JP)

Correspondence Address: IP GROUP OF DLA PIPER RUDNICK GRAY CARY US LLP, 1650 MARKET ST, SUITE 4900, PHILADELPHIA, PA, 19103, US

(21) Appl. No.: 10/530,134

(22) PCT Filed: Jan. 7, 2004
(86) PCT No.: PCT/JP04/00039

§ 371 Date: Jun. 9, 2005

(30) Foreign Application Priority Data
Jan. 17, 2003 (JP) 2003-009795
Jan. 17, 2003 (JP) 2003-009784
Jan. 17, 2003 (JP) 2003-009787

(51) Int. Cl. B22D 7/00; B32B 15/18; B32B 15/20; B32B 15/00

(52) U.S. Cl. 428/638; 428/544; 428/677; 428/683; 428/684

(57) ABSTRACT

A high-strength and high-fatigue-strength steel having a base metal strength of 1000 MPa or more and a rotating bending fatigue strength of 550 MPa or more is provided. The steel contains 0.3-0.8 percent by mass of C, 0.01-0.9 percent by mass of Si, 0.01-2.0 percent by mass of Mn, and Fe and unavoidable impurities as the remainder. The steel has a ferrite-cementite structure having a grain size of 7 μm or less or a ferrite-cementite-pearlite structure having a grain size of 7 μm or less. A surface metal of the steel after high-frequency induction quenching has a martensite structure having a prior austenite grain size of 12 μm or less. Alternatively, a surface metal of the steel after nitriding has a fine structure having a ferrite grain size of 10 μm or less.

### TECHNICAL FIELD

The present invention relates to a high-strength steel having high fatigue strength that is suitable for use in automotive parts made from bar steel, such as constant velocity joints, drive shafts, crank shafts, connecting rods, and hubs, and to a method for manufacturing the high-strength steel.

### BACKGROUND ART

Connecting rods and hubs are manufactured by hot forging or rotary forming and subsequent cutting. Constant velocity joints, drive shafts, crank shafts, and hubs are manufactured by annealing or spheroidize annealing for improved machinability, followed by hot forging or rotary forming, and subsequent partial or whole high-frequency induction quenching or nitriding. Such products require high strength and long fatigue life to achieve vehicle weight reduction.

It is already known that decreasing the maximum size of inclusions and reducing the number of inclusions are the most effective ways to increase the fatigue strength.

For example, Japanese Unexamined Patent Application Publication No. 11-302778 discloses a method for increasing the fatigue strength in which the contents of Al, N, Ti, Zr, S, and other components are properly adjusted, the maximum size of sulfides is 10 μm or less, and the cleanliness is 0.05% or more. However, repeated stress may cause grain boundary cracking particularly in high-strength materials, and thus a target fatigue strength cannot be achieved.

Japanese Unexamined Patent Application Publication No. 11-1749 discloses a method for improving the fatigue characteristics and the rolling fatigue life of a rolled steel wire or a rolled steel rod in which the number of oxides and sulfides that are contained in an area parallel to the longitudinal center and apart from the center by one-fourth of the diameter is 20 or less per 100 mm² unit area. However, this method gives only a maximum fatigue strength of about 770 MPa, which does not meet the recent demand for bending fatigue strength.

### DISCLOSURE OF INVENTION

In light of such existing circumstances, it is an objective of the present invention to provide a high-strength steel that has a strength of 1000 MPa or more and a rotating bending fatigue strength of 550 MPa or more through the proper control of composition and structure, and an advantageous method for manufacturing the high-strength steel.

It is another objective of the present invention to provide a high-strength steel by proper structure control of a base metal and a surface metal, in which the base metal has a strength of 1000 MPa or more and, after high-frequency induction quenching or nitriding, has a rotating bending fatigue strength of 800 MPa or more, and an advantageous method for manufacturing the high-strength steel.

To this end, the present inventors have found the following fact through intense study.

(1) While a fine grain size of a steel results in high strength and high fatigue strength, it is not sufficient to achieve the target fatigue strength of the present invention.

(2) The composition control of the steel structure for generating not only fine ferrite, but also fine cementite effectively increases the fatigue strength. In addition, this finely dispersed cementite increases uniform elongation, thus improving the workability of the material.

(3) In addition to the composition control of the steel, working at 550-700° C. under a strain of 1.0 or more is effective in preparing the steel structure containing the fine ferrite and the fine cementite.

(4) While the fine grain size of the steel results in the high strength and the high fatigue strength, it is not sufficient to achieve the target fatigue strength of the present invention, because the grain size increases during subsequent high-frequency induction quenching.

(5) When the composition is controlled to achieve the steel structure containing the fine ferrite and the fine cementite, the finely dispersed cementite and a ferrite boundary of the base metal act as nuclei in austenitizing during high-frequency heating. Thus, austenitizing occurs at many nuclei, and thereby a prior austenite grain size of the resulting martensite decreases. As a result, the strength and the fatigue strength remarkably increase even after the high-frequency induction quenching.

(6) The effect is larger when the high-frequency induction quenching is performed at relatively low temperature.

(7) While the fine grain size of the steel results in high strength and high fatigue strength, when nitriding is subsequently applied to a surface metal, it is not sufficient to achieve the target fatigue strength of the present invention. This is because the grain size increases during the nitriding.

(8) When the composition is controlled to achieve the steel structure containing the fine ferrite and the fine cementite, the finely dispersed cementite acts as a pinning during nitriding to suppress the growth of the ferrite grain. This decreases the size of the resulting ferrite grain in the surface metal. As a result, the strength and the fatigue strength remarkably increase even after the nitriding.

### BEST MODE FOR CARRYING OUT THE INVENTION

Accordingly, the present invention includes the following aspects:

1. A high-strength steel having high fatigue strength comprising:

C: 0.3-0.8 percent by mass,

Si: 0.01-0.9 percent by mass, and

Mn: 0.01-2.0 percent by mass,

the remainder containing Fe and unavoidable impurities,

wherein the high-strength steel has a ferrite-cementite structure having a grain size of 7 μm or less, or a ferrite-cementite-pearlite structure having a grain size of 7 μm or less.

2. The high-strength steel having high fatigue strength in Paragraph 1, further comprising:

Mo: 0.05-0.6 percent by mass.

3. The high-strength steel having high fatigue strength in Paragraph 2, further comprising at least one selected from the group consisting of:

Al: 0.015-0.06 percent by mass,

Ti: 0.005-0.030 percent by mass,

Ni: 1.0 percent by mass or less,

Cr: 1.0 percent by mass or less,

V: 0.1 percent by mass or less,

Cu: 1.0 percent by mass or less,

Nb: 0.05 percent by mass or less,

Ca: 0.008 percent by mass or less, and

B: 0.004 percent by mass or less.

4. The high-strength steel having high fatigue strength in Paragraph 1, 2, or 3, wherein the percentage of the cementite structure is 4 percent by volume or more.

5. The high-strength steel having high fatigue strength in Paragraph 2, wherein a surface metal of the steel after high-frequency induction quenching has a martensite structure having a prior austenite grain size of 12 μm or less.

6. The high-strength steel having high fatigue strength in Paragraph 5, further comprising at least one selected from the group consisting of:

Al: 0.015-0.06 percent by mass,

Ti: 0.005-0.030 percent by mass,

Ni: 1.0 percent by mass or less,

Cr: 1.0 percent by mass or less,

V: 0.1 percent by mass or less,

Cu: 1.0 percent by mass or less,

Nb: 0.05 percent by mass or less,

Ca: 0.008 percent by mass or less, and

B: 0.004 percent by mass or less.

7. The high-strength steel having high fatigue strength in Paragraph 2, wherein a surface metal of the steel has a hard layer generated by nitriding and the size of a ferrite grain in the surface metal after the nitriding is 10 μm or less.

8. The high-strength steel having high fatigue strength in Paragraph 7, further comprising at least one selected from the group consisting of:

Al: 0.015-0.06 percent by mass,

Ti: 0.005-0.030 percent by mass,

Ni: 1.0 percent by mass or less,

Cr: 1.0 percent by mass or less,

V: 0.1 percent by mass or less,

Cu: 1.0 percent by mass or less,

Nb: 0.05 percent by mass or less,

Ca: 0.008 percent by mass or less, and

B: 0.004 percent by mass or less.

9. The high-strength steel having high fatigue strength in Paragraph 7 or 8, wherein the percentage of the cementite structure in a base metal of the steel is 4 percent by volume or more.

10. A method for manufacturing high-strength steel having high fatigue strength comprising:

processing a raw material containing

C: 0.3-0.8 percent by mass,

Si: 0.01-0.9 percent by mass,

Mn: 0.01-2.0 percent by mass,

Fe, and unavoidable impurities at 550-700° C. under a strain of 1.0 or more.

11. The method for manufacturing high-strength steel having high fatigue strength in Paragraph 10, wherein the raw material further comprises

Mo: 0.05-0.6 percent by mass.

12. The method for manufacturing high-strength steel having high fatigue strength in Paragraph 11, wherein the raw material further comprises at least one selected from the group consisting of:

Al: 0.015-0.06 percent by mass,

Ti: 0.005-0.030 percent by mass,

Ni: 1.0 percent by mass or less,

Cr: 1.0 percent by mass or less,

V: 0.1 percent by mass or less,

Cu: 1.0 percent by mass or less,

Nb: 0.05 percent by mass or less,

Ca: 0.008 percent by mass or less, and

B: 0.004 percent by mass or less.

13. The method for manufacturing high-strength steel having high fatigue strength in Paragraph 11 comprising:

processing the raw material at 550-700° C. under a strain of 1.0 or more, and then

applying high-frequency induction quenching.

14. The method for manufacturing high-strength steel having high fatigue strength in Paragraph 13, wherein the raw material further comprises at least one selected from the group consisting of:

Al: 0.015-0.06 percent by mass,

Ti: 0.005-0.030 percent by mass,

Ni: 1.0 percent by mass or less,

Cr: 1.0 percent by mass or less,

V: 0.1 percent by mass or less,

Cu: 1.0 percent by mass or less,

Nb: 0.05 percent by mass or less,

Ca: 0.008 percent by mass or less, and

B: 0.004 percent by mass or less.

15. The method for manufacturing high-strength steel having high fatigue strength in Paragraph 11 comprising:

processing the raw material at 550-700° C. under a strain of 1.0 or more, and then

applying nitriding to a surface metal of the steel.

16. The method for manufacturing high-strength steel having high fatigue strength in Paragraph 15, wherein the raw material further comprises at least one selected from the group consisting of:

Al: 0.015-0.06 percent by mass,

Ti: 0.005-0.030 percent by mass,

Ni: 1.0 percent by mass or less,

Cr: 1.0 percent by mass or less,

V: 0.1 percent by mass or less,

Cu: 1.0 percent by mass or less,

Nb: 0.05 percent by mass or less,

Ca: 0.008 percent by mass or less, and

B: 0.004 percent by mass or less.

The present invention will be described in detail below. First of all, the reason that the composition of the steel according to the present invention is limited to the range described above will be explained.

C: 0.3-0.8 percent by mass

C is required to increase the strength of the base metal and maintain a required amount of cementite. A C content less than 0.3 percent by mass is insufficient for the effects, while a C content more than 0.8 percent by mass results in poor machinability, low fatigue strength, and poor forgeability. Thus, the C content is limited to 0.3-0.8 percent by mass.

Si: 0.01-0.9 percent by mass

Si acts as a deoxidizer and contributes effectively to high strength. A Si content less than 0.01 percent by mass is insufficient for the effects, while a Si content more than 0.9 percent by mass results in poor machinability and poor forgeability. Thus, the Si content is limited to 0.01-0.9 percent by mass.

Mn: 0.01-2.0 percent by mass

Mn contributes to high strength and high fatigue strength. A Mn content less than 0.01 percent by mass is insufficient for the effects, while a Si content more than 2.0 percent by mass results in poor machinability and poor forgeability. Thus, the Mn content is limited to 0.01-2.0 percent by mass.

In addition to the basic elements described above, other elements described below can be used appropriately in the present invention.

Mo: 0.05-0.6 percent by mass

Mo is useful for effectively retarding the growth of a ferrite grain. This effect requires at least 0.05 percent by mass of Mo. However, a Mo content more than 0.6 percent by mass results in poor machinability. Thus, the Mo content is limited to 0.05-0.6 percent by mass.

Al: 0.015-0.06 percent by mass

Al acts as a deoxidizer for steel. An Al content less than 0.015 percent by mass is insufficient for the effect, while an Al content more than 0.06 percent by mass results in poor machinability and low fatigue strength. Thus, the Al content is limited to 0.015-0.06 percent by mass.

Ti: 0.005-0.030 percent by mass

Ti is useful for making a grain smaller by the pinning effect of TiN. This effect requires at least 0.005 percent by mass of Ti. However, a Ti content more than 0.030 percent by mass results in low fatigue strength. Thus, the Ti content is limited to 0.005-0.030 percent by mass.

Ni: 1.0 percent by mass or less

Ni is effective in increasing the strength and preventing cracking due to the addition of Cu. However, a Ni content more than 1.0 percent by mass may result in quenching cracks. Thus, the Ni content is limited to 1.0 percent by mass or less.

Cr: 1.0 percent by mass or less Cr is effective in increasing the strength. However, more than 1.0 percent by mass of Cr stabilizes carbides and promotes the production of residual carbides. More than 1.0 percent by mass of Cr also reduces the grain boundary strength and decreases the fatigue strength. Thus, the Cr content is limited to 1.0 percent by mass or less.

V: 0.1 percent by mass or less

V can precipitate as a carbide and give a finer structure by pinning. The effect levels off at a V content of 0.1 percent by mass. Thus, the V content is limited to 0.1 percent by mass or less.

Cu: 1.0 percent by mass or less

Cu increases the strength by solid solution strengthening and precipitation strengthening, and also contributes effectively to excellent hardenability. However, a Cu content more than 1.0 percent by mass may cause cracking during hot working, making the manufacturing difficult. Thus, the Cu content is limited to 1.0 percent by mass or less.

Nb: 0.05 percent by mass or less

Nb can precipitate to pin a ferrite grain, but the effect levels off at a Nb content of 0.05 percent by mass. Thus, the Nb content is limited to 0.05 percent by mass or less.

Ca: 0.008 percent by mass or less

Ca generates a spheroidized inclusion and improves fatigue characteristics. However, a Ca content more than 0.008 percent by mass results in a larger inclusion and may deteriorate the fatigue characteristics. Thus, the Ca content is limited to 0.008 percent by mass or less.

B: 0.004 percent by mass or less

B improves the fatigue characteristics by grain boundary strengthening and increases the strength. The effects level off at a B content of 0.004 percent by mass. Thus, the B content is limited to 0.004 percent by mass or less.

While suitable compositions are described above, limiting the composition within the above-mentioned range is not sufficient for the implementation of the present invention. Structure control of the steel is also required, as shown below.

A ferrite-cementite structure having a grain size of 7 μm or less or a ferrite-cementite-pearlite structure having a grain size of 7 μm or less.

When the structure is not a ferrite-cementite structure having a grain size of 7 μm or less or a ferrite-cementite-pearlite structure having a grain size of 7 μm or less, the target strength of 1000 MPa or more of the present invention will not be achieved. Thus, the ferrite grain size is limited to 7 μm or less. Preferably, the ferrite grain size is 5 μm or less.

When the structure of a base metal, that is, the structure before high-frequency induction quenching (corresponding to a part other than a surface quenching structure after the high-frequency induction quenching) is not a ferrite-cementite structure having a grain size of 7 μm or less or a ferrite-cementite-pearlite structure having a grain size of 7 μm or less, the target base metal strength of 1000 MPa or more of the present invention will not be achieved. Furthermore, for a ferrite grain size larger than 7 μm, when high-frequency induction quenching is subsequently applied, a prior austenite grain that is subjected to the high-frequency induction quenching exceeds 12 μm in size, and thereby the fatigue strength will not be improved. Thus, the size of the ferrite grain in the base metal is limited to 7 μm or less. Preferably, it is 5 μm or less.

When the structure of a base metal, that is, the structure before nitriding (corresponding to a part other than a surface-nitrided case after the nitriding) is not a ferrite-cementite structure having a grain size of 7 μm or less or a ferrite-cementite-pearlite structure having a grain size of 7 μm or less, the target base metal strength 1000 MPa or more of the present invention will not be achieved. Furthermore, for a ferrite grain size larger than 7 μm, when nitriding is subsequently applied, a ferrite grain in a nitriding case exceeds 10 μm in size, and thereby the fatigue strength will not be improved. Thus, the size of the ferrite grain in the base metal is limited to 7 μm or less. Preferably, it is 5 μm or less.

A ferrite grain size of 2 μm or less may cause the pearlite structure to disappear, resulting in a ferrite-cementite structure, which does not impair the present invention.

Preferably, the amount (structural fraction) of precipitated cementite is 4 percent by volume fraction (percent by volume) or more. Cementite contributes to high fatigue strength, and cementite that precipitates finely in large quantity increases uniform elongation, improving workability of the material. Preferably, the precipitated cementite has a size of about 1 μm or less, and more preferably 0.5 μm or less. In addition, the amount of precipitated pearlite is preferably about 20 percent by volume or less. As described above, the precipitation of pearlite is not necessary. A structure other than cementite and pearlite is ferrite. Preferably, the amount of ferrite is 40 percent by volume or more to secure workability. The ferrite-cementite structure or the ferrite-cementite-pearlite structure described above can suitably be formed in a warm forging process of steel manufacturing at 550-700° C. under a strain of 1.0 or more.

A martensite structure in which the size of a prior austenite grain in a surface metal is 12 μm or less after high-frequency induction quenching

When a prior austenite grain size is not 12 μm or less, the target bending fatigue strength of 800 MPa or more of the present invention cannot be achieved. Thus, the size of the prior austenite grain in a structure after high-frequency induction quenching is limited to 12 μm or less. Preferably, it is 5 μm or less.

The above-mentioned structure after the high-frequency induction quenching can be formed by using a ferrite-cementite structure having a grain size of 7 μm or less or a ferrite-cementite-pearlite structure having a grain size of 7 μm or less as a base metal structure and applying high-frequency induction quenching to the structure under the conditions described below.

A ferrite grain having a size of 10 μm or less in a surface metal after nitriding

When the size of a ferrite grain in a surface metal after nitriding, that is, a nitrided case is more than 10 μm, the target bending fatigue strength of 800 MPa or more of the present invention cannot be achieved. Thus, the size of the ferrite grain in the surface metal after nitriding is limited to 10 μm or less. Preferably, it is 5 μm or less.

The above-mentioned surface metal structure after nitriding can be formed by using a ferrite-cementite structure having a grain size of 7 μm or less or a ferrite-cementite-pearlite structure having a grain size of 7 μm or less as a base metal structure and applying nitriding to the structure under the conditions described below.

The following are the conditions for manufacturing steel according to the present invention.

A steel that has a predetermined composition is subjected to wire rod rolling and subsequent warm forging. The warm forged steel is used as a base metal. The warm forged steel is finished by, for example, cutting into a final product. Alternatively, the warm forged steel is subjected to cold drawing if necessary, and then to high-frequency induction quenching to yield a final product. Alternatively, the warm forged steel is subjected to working, such as cutting, if necessary, and then to nitriding to yield a final product.

In the warm forging process, working at 550-700° C. under a strain of 1.0 or more is advantageous to form a ferrite grain having a size of 7 μm or less. When the working temperature is below 550° C., the structure keeps a rolling texture and does not decrease in size. On the other hand, when the working temperature is over 700° C., the grain size exceeds 7 μm and also does not decrease in size. When the amount of working is less than 1.0 as determined by strain, the working is insufficient, and the greater part of the structure has small angle boundaries. Thus, not only the strength, but also the fatigue characteristics are not improved.

The base metal structure described above is subjected to high-frequency induction quenching to harden the surface metal. A heating temperature of 800-1000° C. and a frequency of 0.3-400 kHz may be employed as a condition of the high-frequency induction quenching. A heating temperature less than 800° C. results in insufficient austenitizing, and a heating temperature more than 1000° C. results in a coarse austenite grain. A frequency less than 0.3 kHz results in slow and insufficient temperature rise, and a frequency more than 400 kHz results in lesser hardness penetration. Thus, the bending fatigue strength is not improved.

The base metal structure described above is subjected to nitriding to harden the surface metal, and thereby the wear resistance is improved. The nitriding is performed at 500-650° C. for 1-100 hours under a nitriding atmosphere. In the nitriding, a nitrogen source may be in gaseous form or liquid form.

At a nitriding temperature less than 500° C., nitrogen hardly penetrates into the steel, and the nitriding is insufficient. On the other hand, at a nitriding temperature over 650° C., grain growth of the base metal is hardly inhibited, and thus the ferrite grain become large. Nitriding for less than 1 hour causes insufficient penetration of nitrogen, resulting in a lesser nitriding effect. On the other hand, the nitriding effect levels off at 100 hours.

### EXAMPLE 1

Steels that had compositions shown in Table 1 were subjected to rod rolling and subsequent warm forging under conditions shown in Table 2 to yield products 60×60×120 mm in size. Tensile test pieces, rotating bending fatigue test pieces, and machinability test pieces were prepared from the products. The ferrite grain size, the cementite content, the pearlite content, the tensile strength, the rotating bending fatigue strength, and the machinability of the products are shown in Table 2. The strain level during the warm forging was calculated by a finite-element analysis on the assumption that the coefficient of friction of a forged surface was 0.3. Machinability was evaluated by a peripheral turning test on the basis of whether the tool life was equivalent to or longer than that of a SC material in accordance with JIS G5101 (O) or not (X).

As is apparent from Table 2, all the inventive samples that had a ferrite-cementite structure having a grain size of 7 μm or less, or a ferrite-cementite-pearlite structure having a grain size of 7 μm or less according to the present invention exhibited high strengths of 1000 MPa or more, and high rotating bending fatigue strengths of 550 MPa or more.

By contrast, a comparative test piece No. 6 produced at a low strain level during the forging had a large ferrite grain and low rotating bending fatigue strength. A comparative test piece No. 7 produced at a low forging temperature had a rolling texture. On the other hand, a comparative test piece No. 8 produced at a high forging temperature had a large ferrite grain, and therefore had low rotating bending fatigue strength.

A comparative test piece No. 13 containing excess Mo exhibited poor machinability. A comparative test piece No. 14 lacking in C had low strength. On the other hand, a comparative test piece No. 15 containing excess C resulted in poor machinability.

### EXAMPLE 2

Steels that had compositions shown in Table 3 were subjected to rod rolling and subsequent warm forging under conditions shown in Table 4 to yield base metals 60×60×120 mm in size. Tensile test pieces, rotating bending fatigue test pieces, and machinability test pieces were prepared from the base metals. Then, the rotating bending fatigue test pieces were subjected to high-frequency induction quenching at 900° C. and a frequency of 12 kHz. The ferrite grain size, the cementite content, the pearlite content, the tensile strength, and the machinability of the base metal, as well as the prior austenite grain size of a quenching structure after the high-frequency induction quenching, and the rotating bending fatigue strength of the test piece after the high-frequency induction quenching are shown in Table 4. The strain level during the warm forging was calculated by a finite-element analysis on the assumption that the coefficient of friction of a forged surface was 0.3. Machinability was evaluated by a peripheral turning test on the basis of whether the tool life was equivalent to or longer than that of a typical SC material (O) or not (X).

As is apparent from Table 4, all the inventive samples in which the base metals had a ferrite-cementite structure having a grain size of 7 μm or less, or a ferrite-cementite-pearlite structure having a grain size of 7 μm or less according to the present invention exhibited high base metal strengths of 1000 MPa or more, and had surface metals of fine martensite structures in which the prior austenite grain sizes were 12 μm or less after the high-frequency induction quenching, and had high rotating bending fatigue strengths of 800 MPa or more.

In contrast to this, a base metal having the ferrite grain size over 7 μm had low strength, a large prior austenite grain size after the high-frequency induction quenching, and low rotating bending fatigue strength.

In particular, a comparative test piece No. 7 produced at a low forging temperature had a rolling texture. On the other hand, a comparative test piece No. 8 produced at a high forging temperature resulted in a large ferrite grain. In addition, even after such a large ferrite structure was subjected to high-frequency induction quenching, the prior austenite grain size of the resulting martensite was still more than 12 μm.

A comparative test piece No. 12 free of Mo had a fine base metal ferrite grain, but had a large prior austenite grain after the high-frequency induction quenching. On the other hand, a comparative test piece No. 13 containing excess Mo had poor machinability.

A comparative test piece No. 14 lacking in C was not quenched, while a comparative test piece No. 15 containing excess C resulted in poor machinability.

### EXAMPLE 3

Steels that had compositions shown in Table 5 were subjected to rod rolling and subsequent warm forging under conditions shown in Table 6 to yield base metals 60×60×120 mm in size. Tensile test pieces, rotating bending fatigue test pieces, and machinability test pieces were prepared from the base metals. Then, the rotating bending fatigue test pieces were subjected to nitriding under conditions shown in Table 6. The ferrite grain size, the cementite content, the pearlite content, the tensile strength, and the machinability of the base metal, as well as the ferrite grain size in the surface metal and the rotating bending fatigue strength after the nitriding are shown in Table 6. The strain level during the warm forging was calculated by a finite-element analysis on the assumption that the coefficient of friction of a forged surface was 0.3. Machinability was evaluated by a peripheral turning test on the basis of whether the tool life was equivalent to or longer than that of a typical SC material (O) or not (X).

As is apparent from Table 6, all the inventive samples in which the base metals had a ferrite-cementite structure having a grain size of 7 μm or less, or a ferrite-cementite-pearlite structure having a grain size of 7 μm or less according to the present invention exhibited high base metal strengths of 1000 MPa or more. They also had a surface metal of a fine ferrite grain 10 μm or less in size after the nitriding, high rotating bending fatigue strengths of 800 MPa or more, and excellent machinability.

In contrast to this, a base metal having the ferrite grain size over 7 μm had low strength, a large ferrite grain size after the nitriding, and low rotating bending fatigue strength.

In particular, a comparative test piece No. 6 produced at a low forging temperature had a rolling texture. On the other hand, a comparative test piece No. 7 produced at a high forging temperature or a comparative test piece No. 8 of a low strain level during the forging resulted in a large ferrite grain. In addition, even after such a large ferrite structure was subjected to nitriding, the ferrite grain size of the resulting nitrided part was still more than 10 μm.

A comparative test piece No. 13 free of Mo had a fine base metal ferrite grain, but had a large ferrite grain size after the nitriding, resulting in low rotating bending fatigue strength. A comparative test piece No. 1 lacking in C had a large ferrite grain size after the nitriding, low base metal strength, and low rotating bending fatigue strength. On the other hand, a comparative test piece No. 4 containing excess C resulted in poor machinability. A comparative test piece No. 9, which was not subjected to the nitriding, had low rotating bending fatigue strength.

### INDUSTRIAL APPLICABILITY

According to the present invention, a high-strength and high-fatigue-strength steel that has a base metal strength of 1000 MPa or more and a rotating bending fatigue strength of 550 MPa or more or 800 MPa or more can be consistently manufactured.

TABLE 1

| Steel | Composition (mass %) | | | | | | | | | | | | | | | |
|---|---|---|---|---|---|---|---|---|---|---|---|---|---|---|---|---|
| code | C | Si | Mn | Mo | P | S | Al | Cu | Ni | Nb | Cr | Ti | V | B | Ca | Note |
| A | 0.32 | 0.66 | 0.54 | 0.35 | 0.009 | 0.0018 | 0.031 | — | — | 0.020 | — | 0.015 | — | 0.002 | — | Inventive |
| | | | | | | | | | | | | | | | | steel |
| B | 0.41 | 0.66 | 0.55 | 0.36 | 0.012 | 0.0020 | 0.033 | 0.15 | — | — | — | 0.015 | — | — | — | Inventive |
| | | | | | | | | | | | | | | | | steel |
| C | 0.39 | 0.20 | 0.75 | 0.35 | 0.011 | 0.0018 | 0.032 | — | 0.14 | — | 0.30 | 0.015 | — | 0.002 | — | Inventive |
| | | | | | | | | | | | | | | | | steel |
| D | 0.39 | 0.65 | 1.30 | — | 0.009 | 0.0018 | — | — | — | — | — | — | — | — | — | Inventive |
| | | | | | | | | | | | | | | | | steel |
| E | 0.40 | 0.65 | 0.54 | 0.35 | 0.009 | 0.0020 | 0.032 | 0.25 | 0.25 | — | — | 0.015 | — | — | — | Inventive |
| | | | | | | | | | | | | | | | | steel |
| F | 0.40 | 0.82 | 0.30 | 0.35 | 0.010 | 0.0021 | — | — | — | — | — | 0.015 | — | — | — | Inventive |
| | | | | | | | | | | | | | | | | steel |
| G | 0.41 | 0.65 | 0.53 | 0.36 | 0.010 | 0.0018 | 0.031 | — | 0.20 | — | — | — | 0.020 | — | — | Inventive |
| | | | | | | | | | | | | | | | | steel |
| H | 0.41 | 0.66 | 0.54 | 0.35 | 0.009 | 0.0020 | 0.030 | 0.20 | — | — | 0.20 | 0.015 | — | — | 0.004 | Inventive |
| | | | | | | | | | | | | | | | | steel |
| I | 0.40 | 0.64 | 0.53 | — | 0.011 | 0.0018 | 0.033 | — | 0.30 | — | — | 0.015 | — | — | — | Inventive |
| | | | | | | | | | | | | | | | | steel |
| J | 0.40 | 0.65 | 0.54 | 0.75 | 0.009 | 0.0017 | 0.032 | 0.16 | — | 0.020 | — | 0.015 | — | — | — | Comparative |
| | | | | | | | | | | | | | | | | steel |
| K | 0.15 | 0.65 | 0.54 | 0.36 | 0.011 | 0.0021 | 0.031 | — | — | — | — | — | — | — | — | Comparative |
| | | | | | | | | | | | | | | | | steel |
| L | 0.88 | 0.65 | 0.53 | 0.35 | 0.012 | 0.0018 | 0.031 | — | — | — | — | 0.015 | — | — | — | Comparative |
| | | | | | | | | | | | | | | | | steel |

TABLE 2

| | | | | | | | | Rotating | | |
|---|---|---|---|---|---|---|---|---|---|---|
| | | | | | | | Product | bending | | |
| | | Casting | | Ferrite | Cementite | Pearlite | Strength | fatigue | | |
| | Steel | temperature | | grain size | content | content | TS | strength | | |
| No. | code | (° C.) | Strain | (μm) | (vol %) | (vol %) | (MPa) | (MPa) | Machinability | Note |
| 1 | A | 630 | 2.0 | 2.8 | 4.3 | 1.7 | 1039 | 550 | ο | Inventive |
| | | | | | | | | | | example |
| 2 | B | 630 | 1.6 | 2.1 | 5.8 | 0.0 | 1036 | 551 | ο | Inventive |
| | | | | | | | | | | example |
| 3 | C | 630 | 1.4 | 2.0 | 5.6 | 0.0 | 1062 | 554 | ο | Inventive |
| | | | | | | | | | | example |
| 4 | D | 630 | 1.8 | 2.9 | 5.5 | 0.9 | 1043 | 560 | ο | Inventive |
| | | | | | | | | | | example |
| 5 | E | 630 | 1.6 | 2.0 | 5.7 | 0.0 | 1011 | 551 | ο | Inventive |
| | | | | | | | | | | example |
| 6 | E | 630 | 0.6 | 17.0 | 0.7 | 42.6 | 821 | 369 | ο | Comparative |
| | | | | | | | | | | example |
| 7 | E | 500 | 1.7 | Rolling | — | — | 903 | 461 | ο | Comparative |
| | | | | texture | | | | | | example |
| 8 | E | 720 | 1.6 | 21.0 | 0.6 | 43.5 | 807 | 395 | ο | Comparative |
| | | | | | | | | | | example |
| 9 | F | 630 | 1.4 | 2.1 | 5.8 | 0.0 | 1049 | 556 | ο | Inventive |
| | | | | | | | | | | example |
| 10 | G | 630 | 1.6 | 2.4 | 5.8 | 0.0 | 1044 | 574 | ο | Inventive |
| | | | | | | | | | | example |
| 11 | H | 630 | 1.9 | 2.6 | 5.8 | 0.0 | 1044 | 554 | ο | Inventive |
| | | | | | | | | | | example |
| 12 | I | 630 | 1.7 | 2.8 | 5.5 | 0.9 | 1054 | 561 | ο | Inventive |
| | | | | | | | | | | example |
| 13 | J | 630 | 1.9 | 2.4 | 5.7 | 0.0 | 1029 | 576 | X | Comparative |
| | | | | | | | | | | example |
| 14 | K | 630 | 2.1 | 5.2 | 0.9 | 9.4 | 781 | 414 | ο | Comparative |
| | | | | | | | | | | example |
| 15 | L | 630 | 1.9 | 2.2 | 12.9 | 0.0 | 1132 | 571 | X | Comparative |
| | | | | | | | | | | example |

TABLE 3

| Steel | Composition (mass %) | | | | | | | | | | | | | | | |
|---|---|---|---|---|---|---|---|---|---|---|---|---|---|---|---|---|
| code | C | Si | Mn | Mo | P | S | Al | Cu | Ni | Nb | Cr | Ti | V | B | Ca | Note |
| A | 0.35 | 0.75 | 0.60 | 0.40 | 0.010 | 0.0020 | 0.025 | — | — | — | — | 0.02 | — | — | — | Inventive |
| | | | | | | | | | | | | | | | | example |
| B | 0.70 | 0.75 | 0.60 | 0.40 | 0.010 | 0.0020 | 0.025 | — | — | — | — | 0.02 | — | 0.002 | — | Inventive |
| | | | | | | | | | | | | | | | | example |
| C | 0.48 | 0.40 | 0.60 | 0.40 | 0.010 | 0.0020 | — | — | — | — | — | — | — | — | — | Inventive |
| | | | | | | | | | | | | | | | | example |
| D | 0.48 | 0.75 | 0.50 | 0.40 | 0.010 | 0.0020 | 0.025 | — | — | 0.04 | — | 0.02 | 0.02 | 0.002 | — | Inventive |
| | | | | | | | | | | | | | | | | example |
| E | 0.48 | 0.75 | 0.50 | 0.40 | 0.010 | 0.0020 | — | — | — | — | 0.35 | — | — | — | 0.004 | Inventive |
| | | | | | | | | | | | | | | | | example |
| F | 0.48 | 0.75 | 1.20 | 0.40 | 0.010 | 0.0020 | — | 0.2 | — | — | 0.2 | 0.02 | — | — | — | Inventive |
| | | | | | | | | | | | | | | | | example |
| G | 0.48 | 0.75 | 0.60 | 0.40 | 0.010 | 0.0020 | 0.025 | 0.2 | 0.3 | — | — | — | — | 0.002 | 0.002 | Inventive |
| | | | | | | | | | | | | | | | | example |
| H | 0.48 | 0.75 | 0.60 | 0.40 | 0.010 | 0.0020 | 0.050 | — | — | — | — | 0.02 | — | 0.002 | — | Inventive |
| | | | | | | | | | | | | | | | | example |
| I | 0.50 | 0.75 | 0.60 | — | 0.010 | 0.0020 | 0.025 | — | — | — | — | — | — | — | — | Comparative |
| | | | | | | | | | | | | | | | | example |
| J | 0.48 | 0.75 | 0.60 | 0.80 | 0.010 | 0.0020 | 0.025 | — | — | 0.02 | — | — | — | 0.002 | — | Comparative |
| | | | | | | | | | | | | | | | | example |
| K | 0.20 | 0.75 | 0.60 | 0.30 | 0.010 | 0.0020 | 0.025 | — | — | — | — | 0.02 | — | 0.002 | — | Comparative |
| | | | | | | | | | | | | | | | | example |
| L | 0.95 | 0.75 | 0.60 | 0.40 | 0.010 | 0.0020 | 0.025 | 0.2 | 0.2 | — | — | 0.02 | — | — | 0.002 | Comparative |
| | | | | | | | | | | | | | | | | example |

TABLE 4

| | | | | | | | | Base | Rotating | | |
|---|---|---|---|---|---|---|---|---|---|---|---|
| | | | | Ferrite | | | Prior | metal | bending | | |
| | | Casting | | grain | Cementite | Pearlite | austenite | strength | fatigue | | |
| | Steel | temperature | | size | content | content | grain size | TS | strength* | | |
| No. | code | (° C.) | Strain | (μm) | (vol %) | (vol %) | (μm) | (MPa) | (MPa) | Machinability | Note |
| 1 | A | 670 | 2.1 | 2.5 | 4.3 | 5 | 3.4 | 1025 | 843 | ο | Inventive |
| | | | | | | | | | | | example |
| 2 | B | 650 | 1.5 | 2.0 | 10.2 | 0 | 2.7 | 1001 | 817 | ο | Inventive |
| | | | | | | | | | | | example |
| 3 | C | 630 | 1.2 | 2.0 | 6.9 | 0 | 1.4 | 1020 | 843 | ο | Inventive |
| | | | | | | | | | | | example |
| 4 | D | 610 | 1.6 | 1.7 | 6.9 | 0 | 1.5 | 1019 | 823 | ο | Inventive |
| | | | | | | | | | | | example |
| 5 | E | 660 | 1.3 | 2.4 | 6.9 | 0 | 3.3 | 1101 | 868 | ο | Inventive |
| | | | | | | | | | | | example |
| 6 | E | 660 | 0.8 | 16.0 | 2.0 | 42 | 15.9 | 701 | 630 | ο | Comparative |
| | | | | | | | | | | | example |
| 7 | E | 540 | 1.5 | Rolling | — | — | 17.0 | 935 | 603 | ο | Comparative |
| | | | | texture | | | | | | | example |
| 8 | E | 760 | 1.5 | 22.0 | 0 | 59 | 20.0 | 695 | 625 | ο | Comparative |
| | | | | | | | | | | | example |
| 9 | F | 670 | 1.7 | 2.6 | 6.0 | 7.6 | 3.4 | 1106 | 867 | ο | Inventive |
| | | | | | | | | | | | example |
| 10 | G | 600 | 1.6 | 1.9 | 6.7 | 1.6 | 1.2 | 1140 | 865 | ο | Inventive |
| | | | | | | | | | | | example |
| 11 | H | 640 | 1.2 | 2.0 | 6.7 | 1.6 | 2.5 | 1016 | 859 | ο | Inventive |
| | | | | | | | | | | | example |
| 12 | I | 650 | 1.2 | 2.2 | 6.0 | 10 | 21.0 | 1013 | 617 | ο | Comparative |
| | | | | | | | | | | | example |
| 13 | J | 570 | 1.6 | 0.9 | 6.9 | 0 | 1.5 | 1096 | 863 | X | Comparative |
| | | | | | | | | | | | example |
| 14 | K | 620 | 1.2 | 1.7 | 2.7 | 0 | — | 743 | 395 | ο | Comparative |
| | | | | | | | | | | | example |
| 15 | L | 680 | 1.3 | 1.5 | 13.5 | 3.6 | 3.0 | 1150 | 863 | X | Comparative |
| | | | | | | | | | | | example |

*Rotating bending fatigue strength after high-frequency induction quenching

TABLE 5

| Steel | Composition (mass %) | | | | | | | | | | | | | | | |
|---|---|---|---|---|---|---|---|---|---|---|---|---|---|---|---|---|
| code | C | Si | Mn | Mo | P | S | Al | Nb | Cu | Ni | Cr | Ti | V | B | Ca | Note |
| A | 0.25 | 0.69 | 0.60 | 0.42 | 0.012 | 0.0023 | — | — | — | — | — | 0.017 | — | — | — | Comparative |
| | | | | | | | | | | | | | | | | steel |
| B | 0.32 | 0.65 | 0.62 | 0.41 | 0.008 | 0.0019 | 0.023 | 0.015 | — | 0.20 | — | — | 0.04 | 0.017 | — | Inventive |
| | | | | | | | | | | | | | | | | steel |
| C | 0.76 | 0.65 | 0.64 | 0.43 | 0.009 | 0.0019 | 0.025 | — | — | — | 0.25 | 0.018 | — | — | 0.002 | Inventive |
| | | | | | | | | | | | | | | | | steel |
| D | 0.92 | 0.68 | 0.64 | 0.42 | 0.011 | 0.0020 | 0.026 | — | 0.20 | — | — | — | — | 0.0021 | — | Comparative |
| | | | | | | | | | | | | | | | | steel |
| E | 0.51 | 0.20 | 0.60 | 0.42 | 0.008 | 0.0021 | — | — | — | — | — | — | — | — | — | Inventive |
| | | | | | | | | | | | | | | | | steel |
| F | 0.51 | 0.75 | 0.64 | 0.39 | 0.009 | 0.0021 | 0.022 | — | — | 0.15 | — | 0.017 | — | 0.0015 | — | Inventive |
| | | | | | | | | | | | | | | | | steel |
| G | 0.51 | 0.66 | 0.20 | 0.42 | 0.010 | 0.0019 | 0.025 | — | 0.20 | — | — | 0.019 | — | — | — | Inventive |
| | | | | | | | | | | | | | | | | steel |
| H | 0.53 | 0.66 | 1.50 | 0.42 | 0.009 | 0.0019 | — | — | — | — | 0.30 | 0.017 | — | 0.0018 | — | Inventive |
| | | | | | | | | | | | | | | | | steel |
| I | 0.54 | 0.68 | 0.63 | — | 0.008 | 0.0020 | — | — | 0.10 | 0.30 | — | — | — | — | 0.015 | Comparative |
| | | | | | | | | | | | | | | | | steel |
| J | 0.54 | 0.68 | 0.63 | 0.15 | 0.008 | 0.0020 | 0.025 | — | — | — | — | — | — | 0.0019 | 0.002 | Inventive |
| | | | | | | | | | | | | | | | | steel |
| K | 0.50 | 0.25 | 0.61 | 0.50 | 0.007 | 0.0022 | 0.040 | — | — | — | — | 0.019 | — | — | — | Inventive |
| | | | | | | | | | | | | | | | | steel |

TABLE 6

| | | | | | | | | Ferrite | Rotating | | | |
|---|---|---|---|---|---|---|---|---|---|---|---|---|
| | | | | Ferrite | | | | grain size | bending | Base | | |
| | | Casting | | grain | Cementite | Pearlite | | after | fatigue | metal | | |
| | Steel | temperature | | size | content | content | Nitriding | nitriding | strength* | TS | | |
| No. | code | (° C.) | Strain | (μm) | (vol %) | (vol %) | condition | (μm) | (MPa) | (MPa) | Machinability | Note |
| 1 | A | 630 | 1.6 | 2.1 | 3.4 | 0.0 | 540° C. × 24 h in | 17.0 | 684 | 982 | ο | Comparative |
| | | | | | | | molten cyanide | | | | | example |
| 2 | B | 630 | 1.7 | 1.8 | 4.5 | 0.0 | 540° C. × 24 h in | 2.3 | 811 | 1033 | ο | Inventive |
| | | | | | | | molten cyanide | | | | | example |
| 3 | C | 630 | 1.8 | 2.2 | 10.0 | 9.2 | 540° C. × 24 h in | 2.8 | 832 | 1098 | ο | Inventive |
| | | | | | | | molten cyanide | | | | | example |
| 4 | D | 630 | 1.9 | 2.0 | 13.5 | 0.0 | 540° C. × 24 h in | 2.1 | 784 | 1151 | X | Comparative |
| | | | | | | | molten cyanide | | | | | example |
| 5 | E | 630 | 1.5 | 1.9 | 7.3 | 0.0 | 540° C. × 24 h in | 2.2 | 825 | 1072 | ο | Inventive |
| | | | | | | | molten cyanide | | | | | example |
| 6 | E | 550 | 1.5 | Rolling | — | — | 540° C. × 24 h in | — | 653 | — | ο | Comparative |
| | | | | texture | | | molten cyanide | | | | | example |
| 7 | E | 720 | 1.5 | 25.0 | 6.5 | 7.2 | 540° C. × 24 h in | 25.5 | 648 | 1025 | ο | Comparative |
| | | | | | | | molten cyanide | | | | | example |
| 8 | E | 630 | 0.7 | 20.0 | 6.0 | 12.0 | 540° C. × 24 h in | 24.0 | 636 | 1023 | ο | Comparative |
| | | | | | | | molten cyanide | | | | | example |
| 9 | E | 630 | 1.8 | 2.3 | 7.3 | 0.0 | No nitriding | — | 570 | 1037 | ο | Comparative |
| | | | | | | | | | | | | example |
| 10 | F | 630 | 2.0 | 2.2 | 7.3 | 0.0 | 550° C. × 40 h in | 2.6 | 833 | 1039 | ο | Inventive |
| | | | | | | | NH₃ atmosphere | | | | | example |
| 11 | G | 630 | 1.3 | 2.0 | 7.3 | 0.0 | 550° C. × 40 h in | 2.6 | 805 | 1026 | ο | Inventive |
| | | | | | | | NH₃ atmosphere | | | | | example |
| 12 | H | 630 | 1.8 | 2.0 | 7.6 | 0.0 | 550° C. × 40 h in | 2.2 | 848 | 1028 | ο | Inventive |
| | | | | | | | NH₃ atmosphere | | | | | example |
| 13 | I | 630 | 1.6 | 1.9 | 7.8 | 0.0 | 550° C. × 40 h in | 8.5 | 711 | 1035 | ο | Comparative |
| | | | | | | | NH₃ atmosphere | | | | | example |
| 14 | J | 630 | 1.7 | 2.2 | 7.8 | 0.0 | 550° C. × 40 h in | 2.8 | 807 | 1041 | ο | Inventive |
| | | | | | | | NH₃ atmosphere | | | | | example |
| 15 | K | 620 | 1.6 | 2.0 | 7.2 | 0.0 | 550° C. × 40 h in | 2.6 | 844 | 1021 | ο | Inventive |
| | | | | | | | NH₃ atmosphere | | | | | example |

*Rotating bending fatigue strength after nitriding

1. A high-strength steel having high fatigue strength comprising:
C: 0.3-0.8 percent by mass,
Si: 0.01-0.9 percent by mass, and
Mn: 0.01-2.0 percent by mass,
the remainder containing Fe and unavoidable impurities,
wherein the high-strength steel has a ferrite-cementite structure having a grain size of 7 μm or less, or a ferrite-cementite-pearlite structure having a grain size of 7 μm or less:

2. The high-strength steel having high fatigue strength according to claim 1, further comprising:
Mo: 0.05-0.6 percent by mass.

3. The high-strength steel having high fatigue strength according to claim 2, further comprising at least one selected from the group consisting of:
Al: 0.015-0.06 percent by mass,
Ti: 0.005-0.030 percent by mass,
Ni: 1.0 percent by mass or less,
Cr: 1.0 percent by mass or less,
V: 0.1 percent by mass or less,
Cu: 1.0 percent by mass or less,
Nb: 0.05 percent by mass or less,
Ca: 0.008 percent by mass or less, and
B: 0.004 percent by mass or less.

4. The high-strength steel having high fatigue strength according to claim 1, 2, or 3, wherein the percentage of the cementite structure is 4 percent by volume or more.

5. The high-strength steel having high fatigue strength according to claim 2, wherein a surface metal of the steel after high-frequency induction quenching has a martensite structure having a prior austenite grain size of 12 μm or less.

6. The high-strength steel having high fatigue strength according to claim 5, further comprising at least one selected from the group consisting of:
Al: 0.015-0.06 percent by mass,
Ti: 0.005-0.030 percent by mass,
Ni: 1.0 percent by mass or less,
Cr: 1.0 percent by mass or less,
V: 0.1 percent by mass or less,
Cu: 1.0 percent by mass or less,
Nb: 0.05 percent by mass or less,
Ca: 0.008 percent by mass or less, and
B: 0.004 percent by mass or less.

7. The high-strength steel having high fatigue strength according to claim 2, wherein a surface metal of the steel has a quench-hardened case generated by nitriding and the size of a ferrite grain in the surface metal after the nitriding is 10 μm or less.

8. The high-strength steel having high fatigue strength according to claim 7, further comprising at least one selected from the group consisting of:
Al: 0.015-0.06 percent by mass,
Ti: 0.005-0.030 percent by mass,
Ni: 1.0 percent by mass or less,
Cr: 1.0 percent by mass or less,
V: 0.1 percent by mass or less,
Cu: 1.0 percent by mass or less,
Nb: 0.05 percent by mass or less,
Ca: 0.008 percent by mass or less, and
B: 0.004 percent by mass or less.

9. The high-strength steel having high fatigue strength according to claim 7 or 8, wherein the percentage of the cementite structure in a base metal of the steel is 4 percent by volume or more.

10. A method for manufacturing high-strength steel having high fatigue strength comprising:
processing a raw material containing
C: 0.3-0.8 percent by mass,
Si: 0.01-0.9 percent by mass,
Mn: 0.01-2.0 percent by mass,
Fe, and unavoidable impurities at 550-700° C. under a strain of 1.0 or more.

11. The method for manufacturing high-strength steel having high fatigue strength according to claim 10, wherein the raw material further comprises
Mo: 0.05-0.6 percent by mass.

12. The method for manufacturing high-strength steel having high fatigue strength according to claim 11, wherein the raw material further comprises at least one selected from the group consisting of:
Al: 0.015-0.06 percent by mass,
Ti: 0.005-0.030 percent by mass,
Ni: 1.0 percent by mass or less,
Cr: 1.0 percent by mass or less,
V: 0.1 percent by mass or less,
Cu: 1.0 percent by mass or less,
Nb: 0.05 percent by mass or less,
Ca: 0.008 percent by mass or less, and
B: 0.004 percent by mass or less.

13. The method for manufacturing high-strength steel having high fatigue strength according to claim 11 comprising:
processing the raw material at 550-700° C. under a strain of 1.0 or more, and then
applying high-frequency induction quenching.

14. The method for manufacturing high-strength steel having high fatigue strength according to claim 13, wherein the raw material further comprises at least one selected from the group consisting of:
Al: 0.015-0.06 percent by mass,
Ti: 0.005-0.030 percent by mass,
Ni: 1.0 percent by mass or less,
Cr: 1.0 percent by mass or less,
V: 0.1 percent by mass or less,
Cu: 1.0 percent by mass or less,
Nb: 0.05 percent by mass or less,
Ca: 0.008 percent by mass or less, and
B: 0.004 percent by mass or less.

15. The method for manufacturing high-strength steel having high fatigue strength according to claim 11 comprising:
processing the raw material at 550-700° C. under a strain of 1.0 or more, and then
applying nitriding to a surface metal of the steel.

16. The method for manufacturing high-strength steel having high fatigue strength according to claim 15, wherein the raw material further comprises at least one selected from the group consisting of:
Al: 0.015-0.06 percent by mass,
Ti: 0.005-0.030 percent by mass,
Ni: 1.0 percent by mass or less,
Cr: 1.0 percent by mass or less,
V: 0.1 percent by mass or less,
Cu: 1.0 percent by mass or less,
Nb: 0.05 percent by mass or less,
Ca: 0.008 percent by mass or less, and
B: 0.004 percent by mass or less.
